(19) United States
(12) Patent Application Publication
(10) Pub. No.: US 2007/0164982 A1
(43) Pub. Date: Jul. 19, 2007

(54) Electrophoretic display with uniform image stability regardless of the initial optical states

(75) Inventor: Guofu Zhou, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,254

(22) PCT Filed: Mar. 22, 2005
(86) PCT No.: PCT/IB05/50976

§ 371 Date: Sep. 23, 2006

Related U.S. Application Data
(60) Provisional application No. 60/556,167, filed on Mar. 25, 2004.

(51) Int. Cl. G09G 3/34

(52) U.S. Cl. 345/107

(57) ABSTRACT

Respective voltage waveforms (700, 720, 740, 760; 800, 820, 840, 860, 900, 920, 940, 960; 1000, 1020, 1040, 1060) are provided for driving respective portions, e.g., pixels, of a bi-stable display (310) such as an electrophoretic display, to a common final optical state. Each waveform includes a driving pulse (D) for driving the respective display portion from a different initial optical state to substantially the common final optical state. The respective voltage waveforms further include at least one re-addressing pulse (RP, RP1, RP2, RP3), which has substantially the same pulse shape in each of the waveforms. The pulse shape may include pulses of alternating polarity, which have substantially the same energy. The re-addressing pulses adjust the particle configurations of the respective display portions such that each display portion has a uniform brightness decay versus unpowered holding time characteristic (1100, 1110, 1120, 1130).

The invention relates generally to electronic reading devices such as electronic books and electronic newspapers and, more particularly, to a method and apparatus for achieving and maintaining a uniform brightness in a bi-stable display such as an electrophoretic display regardless of an initial optical image state.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in blue liquid.

Other fluids such as air may also be used in the medium in which the charged black and white particles move around in an electric field (e.g., Bridgestone SID2003—Symposium on Information Displays. May 18-23, 2003,—digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

However, a technique is needed for achieving and maintaining a uniform brightness in a bi-stable display such as an electrophoretic display regardless of an initial optical image state.

The invention addresses the above and other issues.

In a particular aspect of the invention, a method provides respective voltage waveforms for driving respective portions of a bi-stable display. The method includes accessing data defining the respective voltage waveforms, and generating the respective voltage waveforms for driving the respective portions of the bi-stable display according to the accessed data so that each of the respective voltage waveforms is used for driving the respective portion of the bi-stable display from a respective different initial optical state to a common final optical state, and each of the respective voltage waveforms includes at least a first re-addressing pulse.

For example, each of the respective voltage waveforms may include the at least a first re-addressing pulse with substantially the same pulse shape and/or energy in each of the respective voltage waveforms.

A related electronic reading device and program storage device are also provided.

In the drawings:

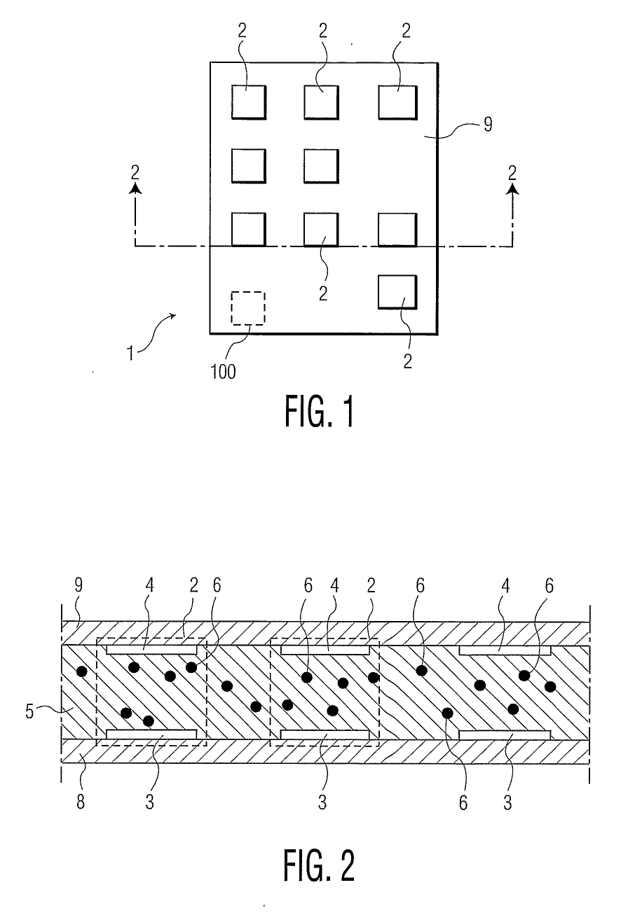

FIG. 1 shows diagramatically a front view of an embodiment of a portion of a display screen of an electronic reading device;

FIG. 2 shows diagramatically a cross-sectional view along 2-2 in FIG. 1;

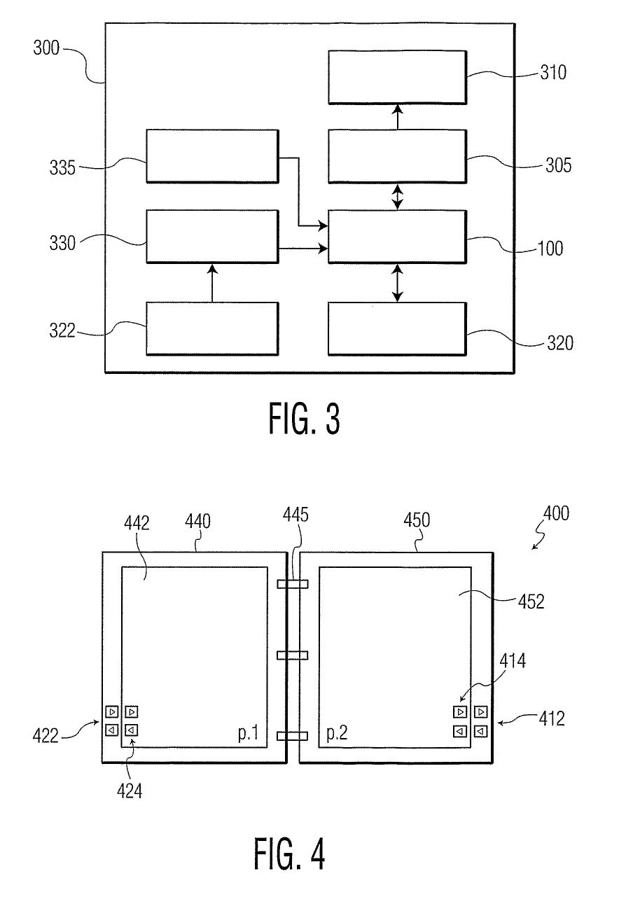

FIG. 3 shows diagramatically an overview of an electronic reading device;

FIG. 4 shows diagramatically two display screens with respective display regions;

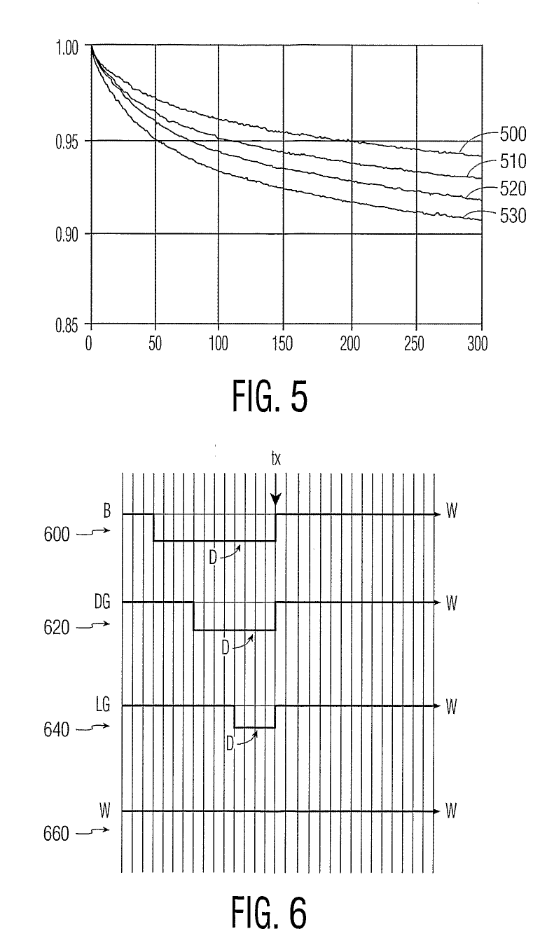

FIG. 5 illustrates a decrease in relative brightness as a function of unpowered image holding time (in seconds) after addressing to the white state from four different initial optical states, using the waveforms of FIG. 6;

FIG. 6 illustrates example waveforms for driving a bi-stable display to the white state from four different initial optical states;

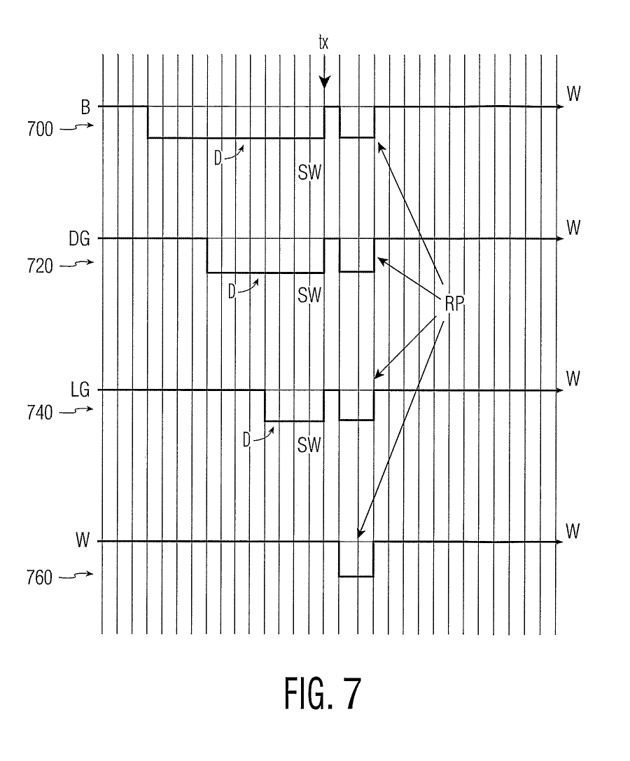

FIG. 7 illustrates the example waveforms of FIG. 6, where a single re-addressing pulse with the same energy and pulse shape in each waveform is also applied;

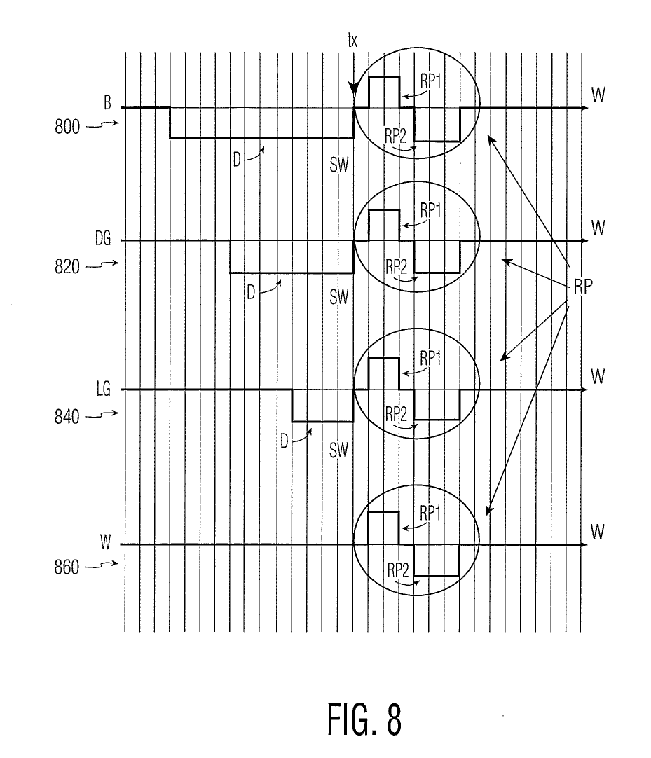

FIG. 8 illustrates the example waveforms of FIG. 6, where two re-addressing pulses with the same energy and pulse shape in each waveform are also applied;

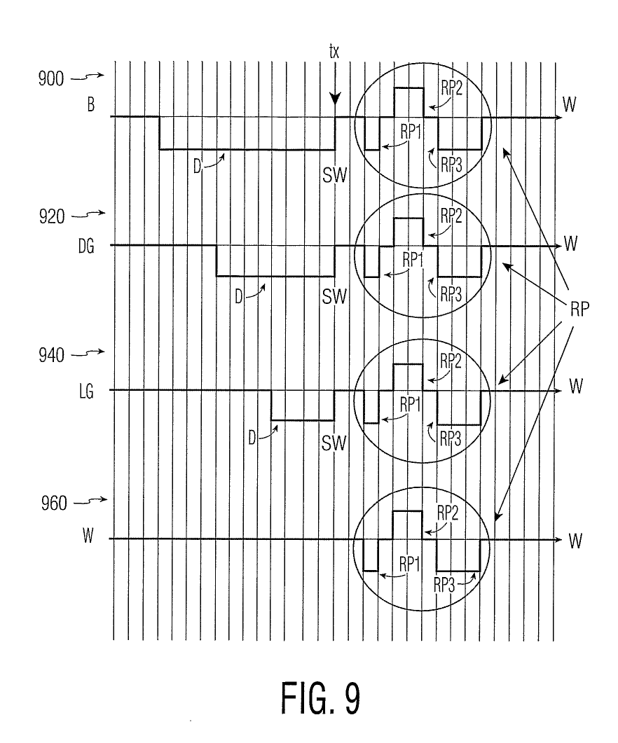

FIG. 9 illustrates the example waveforms of FIG. 6, where three re-addressing pulses with the same energy and pulse shape in each waveform are also applied;

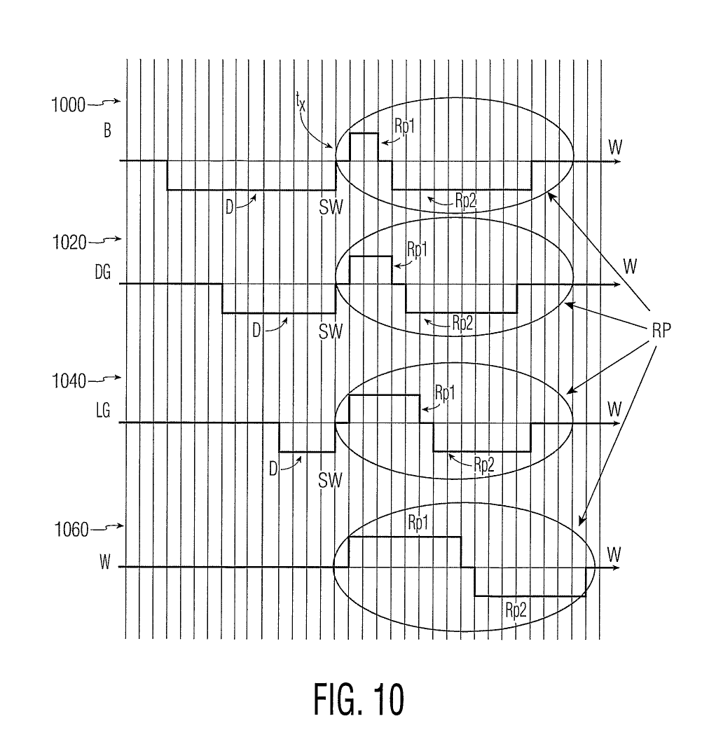

FIG. 10 illustrates the example waveforms of FIG. 6, where two re-addressing pulses with the different energies but the same pulse shape in each waveform are also applied; and

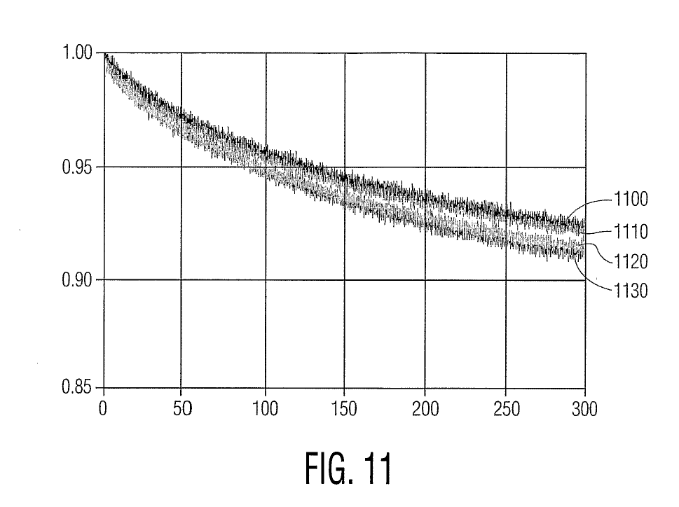

FIG. 11 illustrates a plot showing a decrease in relative brightness as a function of unpowered image holding time (in seconds) after addressing to the white state from four different initial optical states, using the waveforms of FIG. 8.

In all the Figures, corresponding parts are referenced by the same reference numerals.

Each of the following is incorporated herein by reference:

European patent application EP 02078823.8, entitled “Electrophoretic Display Panel”, filed Sep. 16, 2002 (docket no. PHNL 020844);

European patent application EP 03100133.2, entitled “Electrophoretic display panel”, filed Jan. 23, 2003 (docket no. PHNL 030091);

European patent application EP 02077017.8, entitled “Display Device”, filed May 24, 2002, or WO 03/079323, Electrophoretic Active Matrix Display Device”, published Feb. 6, 2003 (docket no. PHNL 020441); and

European patent application EP 03101705.6, entitled “Electrophoretic Display Unit”, filed Jun. 11, 2003 (docket no. PHNL 030661).

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. An application-specific integrated circuit (ASIC) 100 controls the potential difference of each picture element 2 to create a desired picture, e.g. images and/or text, in a full display screen. The full display screen is made up of numerous picture elements that correspond to pixels in a display.

FIG. 3 shows diagramatically an overview of an electronic reading device. The electronic reading device 300 includes the display ASIC 100. For example, the ASIC 100 may be the Philips Corp. “Apollo” ASIC E-ink display controller. The display ASIC 100 controls the one or more display screens 310, such as electrophoretic screens, via an addressing circuit 305, to cause desired text or images to be displayed. The addressing circuit 305 includes driving integrated circuits (ICs). For example, the display ASIC 100 may act as a voltage source that provides voltage waveforms, via an addressing circuit 305, to the different pixels in the display screen 310. The addressing circuit 305 provides information for addressing specific pixels, such as row and column, to cause the desired image or text to be displayed. The display ASIC 100 causes successive pages to be displayed starting on different rows and/or columns. The image or text data may be stored in a memory 320, which represents one or more storage devices, and accessed by the ASIC 100 as needed. One example is the Philips Electronics small form factor optical (SFFO) disk system, in other systems a non-volatile flash memory could be utilized. The electronic reading device 300 further includes a reading device controller 330 or host controller, which may be responsive to a user-activated software or hardware button 322 that initiates a user command such as a next page command or previous page command.

The reading device controller 330 may be part of a computer that executes any type of computer code devices, such as software, firmware, micro code or the like, to achieve the functionality described herein. Accordingly, a computer program product comprising such computer code devices may be provided in a manner apparent to those skilled in the art. The reading device controller 330 may further comprise a memory (not shown) that is a program storage device that tangibly embodies a program of instructions executable by a machine such as the reading device controller 330 or a computer to perform a method that achieves the functionality described herein. Such a program storage device may be provided in a manner apparent to those skilled in the art.

The display ASIC 100 may have logic for periodically providing a forced reset of a display region of an electronic book, e.g., after every x pages are displayed, after every y minutes, e.g., ten minutes, when the electronic reading device 300 is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The ASIC 100 provides instructions to the display addressing circuit 305 for driving the display 310 by accessing information stored in the memory 320.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into or two or more display regions arranged, e.g., horizontally or vertically. Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

Problem Addressed

Bi-stable displays such as electrophoretic displays are advantageous compared to other displays such as LCDs in terms of their high brightness, high contrast ratio, wide view angle and bi-stable or image stable characteristics. Additionally, the average power consumption is much lower than with LCDs due to lower refresh rates afforded by the bi-stability. That is, after the completion of the image update, the image is substantially held on the pixel without supplying any voltage pulse. A voltage pulse is only needed during the next image update. It is also possible to not update/refresh the pixels on which the optical state does not change during the next image update, e.g., in a white-to-white transition, resulting in still lower power consumption. However, in practical electrophoretic displays, it is observed that the optical state drifts away during the unpowered image-holding period directly after the image update, as illustrated in FIG. 5.

FIG. 5 illustrates a decrease in relative brightness as a function of unpowered image holding time (in seconds) directly after addressing to the white state from four different initial optical states. The vertical axis indicates a relative brightness drop of the white state, where 1.00 denotes no brightness drop, while the horizontal axis indicates the unpowered waiting time in seconds. Curves 500, 510, 520 and 530 denote the brightness drop when the white state is reached from white, light grey, dark grey, and black, respectively. The significant brightness drop has led to a requirement in some devices to refresh the display after a certain amount of time, such as ten minutes. The data in FIG. 5 is obtained using the addressing waveforms shown in FIG. 6, discussed further below.

Moreover, the four curves are largely divergent. For example, at the same waiting time, the brightness of the white state when reached from an initial state of black (curve 530) is always lower than the brightness of the white state when reached from an initial state of dark grey (curve 520), which in turn is lower than the brightness of the white state when reached from an initial state of light grey (curve 510). Generally, the speed or rate at which the brightness decays is proportional to the distance that the particles in the display have been moved during the addressing period. As a result of the different brightness decay rates, ghosting appears. Furthermore, the ghosting level is intensified with increasing waiting time. That is, many white states with different reflectivity appear on the display screen due to different subsequent image updates from different initial optical states and different waiting times. This ghosting can become quickly unacceptable, in particular, when a white state is used as the background of the display, as is often the case, e.g., in practical e-reading devices. A similar problem can be encountered when the display experiences a significant unpowered holding time in other optical states, e.g. black, dark grey or light grey. This problem must be addressed to ensure a satisfactory experience by the user.

FIG. 6 illustrates example waveforms for driving a bi-stable display to the white state from four different initial optical states. The waveforms 600, 620 and 640 include a driving pulse (D) for driving the particles of the display from the black (B), dark grey (DG), or light grey (LG) state, respectively, to the white state (W). The waveform 660 includes frames with a substantially zero voltage. Each vertical line in the figure indicates the start and end of a frame time, which may be, e.g., 20 ms. The driving pulses (D) may assume amplitudes of −15 V, 0 V or +15 V in a possible pulse width modulated (PWM) driving scheme. The energy of the driving pulse, which is the product of the duration and the amplitude, is sufficient to drive the particles in the display from the current optical state to the desired final optical state. The brightness drop data of curves 530, 520, 510 and 500 FIG. 5 is obtained using the waveforms 600, 620, 640, and 660, respectively. Moreover, in this and the subsequent figures, the vertical arrow designated by the time index tx indicates the completion time of the driving pulses. The time is concurrent with the time of zero seconds in FIG. 5, at which time the brightness begins to decay.

Proposed Solution

The present invention provides a driving technique for a bi-stable display such as an electrophoretic display that achieves a uniform image stability. In particular, the invention achieves a substantially convergent brightness decay versus unpowered image holding time characteristic for a common final optical state, e.g., white, that is reached from different initial optical states, e.g. black, dark grey, light grey or white. To this end, at least one re-addressing pulse is added to the driving waveforms. In one possible approach, the same re-addressing pulse is used in all waveform transitions to a common final optical state. The re-addressing pulses may be substantially identical voltage impulses that are provided after the completion of the “standard” driving waveforms. A “standard” driving waveform includes a driving waveform comprising substantially single voltage polarity pulse(s) that are just able to move a particle substantially in one direction towards the desired final optical state. A re-addressing pulse moves a particle in one or more directions. As a result, there is no substantial net change of the final optical state. Moreover, importantly, the re-addressing pulses re-configure the particles/ions in the display device. In particular, the re-addressing pulses in the respective driving waveforms may have substantially the same/identical pulse shape or configuration to create substantially the same final particle configuration, resulting in a common brightness decay characteristic. In this way, the image retention effects are massively reduced.

The pulse shape refers, e.g., to the number of re-addressing pulses and the sequence of polarities of the re-addressing pulses. The re-addressing may include single or multiple voltage pulses. For example, a pulse shape may be defined by a first re-addressing pulse with a positive polarity in each waveform. Or, the pulse shape may be defined by a first re-addressing pulse with a positive polarity followed by a second re-addressing pulse with a negative polarity, and so forth. The amplitude and timing of each pulse in each waveform may vary. While the re-addressing pulse shape is substantially the same in all waveforms, the energy of the re-addressing pulses can vary in the different waveforms. However, it is also possible for the energy of the re-addressing pulses to be substantially the same in the different waveforms. The pulse shape is independent of the driving method, e.g., pulse-width-modulated (PWM) or voltage-modulated (VM) driving schemes.

### Embodiment 1

FIG. 7 illustrates the example waveforms of FIG. 6, where a single re-addressing pulse with the same energy and pulse shape in each waveform is also applied. The set of waveforms 700, 720, 740 and 760 are used for transitions to the final optical state of white from the initial optical states of black, dark grey, light grey and white, respectively. In this and the subsequent figures, SW denotes a substantially white state that is reached using the standard driving pulse (D). The waveforms 700, 720, 740 and 760 each include a single re-addressing pulse (RP), which may be the same for each waveform. That is, each re-addressing pulse (RP) may have the same energy, e.g., the same duration, when PWM is used. Moreover, each re-addressing pulse (RP) has the same pulse shape or polarity. This polarity may be the same as the polarity of the driving pulses (D) or the last voltage pulse of the standard driving waveforms. When the polarity of this re-addressing pulse (RP) is the same as that of the last voltage pulse of the standard driving waveform, the re-addressing pulse would act as an overdrive pulse in all respective waveforms, resulting in a brighter white state on all these addressed pixels. In another possible approach, the polarity of the re-addressing voltage pulse (RP) is opposite the polarity of the last voltage pulse of the standard driving waveforms. In this case, the standard driving waveforms will need to comprise a substantial “overdrive” portion that extends the driving pulse duration.

The single re-addressing pulse (RP) may be applied in all four transitions after completion of the standard driving pulses (D). For example, the single re-addressing pulse (RP) may be applied one frame after completion of the standard drive pulses (D) at time tx. Moreover, the re-addressing pulses may be aligned in time in one or more common frame periods. As mentioned, by applying the same re-addressing pulse (RP) in all four transitions, a generally convergent brightness decay curve is obtained because similar configurations of ions/particles are created in the final, white state regardless of the different initial optical states.

Each of the respective voltage waveforms 700, 720, 740 and 760 drives a respective portion, such as one or more pixels, of the bi-stable display (310) according to voltage waveform data that is accessed, e.g., from memory. Each of the respective voltage waveforms is used for driving the respective portion of the bi-stable display from a respective different initial optical state, e.g., black, dark grey, light grey or white, to the common final optical state, e.g., white. Each of the respective voltage waveforms includes one or more re-addressing pulses.

In this and the subsequent figures, the time between the standard waveform and the re-addressing pulse can be varied from zero ms to any time period.

### Embodiment 2

FIG. 8 illustrates the example waveforms of FIG. 6, where two re-addressing pulses with the same energy and pulse shape in each waveform are also applied. The waveforms 800, 820, 840 and 860 are used for transitions to the final optical state of white from the initial optical states of black, dark grey, light grey and white, respectively. The waveforms 800, 820, 840 and 860 each include two re-addressing pulses (RP1, RP2), which may have the same pulse shape for each waveform. Here, the pulse shape is defined by a first re-addressing pulse (RP1) with a positive polarity followed by a second re-addressing pulse (RP2) with a negative polarity.

In this approach, identical bi-polar re-addressing voltage pulses are applied in all four transitions after completion of the standard driving pulse (D) at time tx. The bi-polar pulses may be configured such that the first re-addressing pulse (RP1) moves the particles away from the surface of the display associated with the SW state. In this case, the first re-addressing pulse (RP1) has a polarity opposite to that of the standard driving pulse (D). The second re-addressing pulse (RP2), which may have the same polarity as the standard driving pulse (D), brings the particles back toward the correct brightness.

### Embodiment 3

FIG. 9 illustrates the example waveforms of FIG. 6, where three re-addressing pulses with the same energy and pulse shape in each waveform are also applied. The waveforms 900, 920, 940 and 960 are used for transitions to the final state of white from the initial optical states of black, dark grey, light grey and white, respectively. The waveforms 900, 920, 940 and 960 each include three re-addressing pulses (RP1, RP2 and RP3), which may be the same for each waveform. Here, the pulse shape is defined by a first re-addressing pulse (RP1) with a negative polarity followed by a second re-addressing pulse (RP2) with a positive polarity, followed in turn by a third re-addressing pulse (RP3) with a negative polarity, which is the same as the first polarity.

In this approach, identical triple-voltage pulses with alternating polarities are applied in all four transitions after completion of the standard driving pulse (D). The triple re-addressing pulses may be configured such that the first re-addressing pulse (RP1) compensates for remnant direct current (DC), if any, and/or to enhances the brightness of the white state. In particular, a remnant or residual DC may be built, e.g., in the adhesive layer or capsule layer of the display device due to the application of the addressing waveforms. The average (sum) DC of the waveforms should be minimized in a certain closed image transition loop process called DC-balancing. The closed image transitions loops may include, e.g., B-DG-B or B-DG-LG-W-B or zero. DC balance is generally achieved by adhering to impulse potential theory. The waveform is constructed so that there is no net impulse (DC) for all sets of image transitions that bring the display from an initial optical state to one or more intermediate optical states through an arbitrary set of states, and back to the initial state.

In the example shown, the polarity of the first re-addressing pulse (RP1) is the same as that of the driving pulse (D). The second re-addressing pulse (RP2), whose polarity is opposite to that of the standard driving pulse (D), moves the particles away from the surface of the display associated with the substantially white (SW) state. The third re-addressing pulse (RP3) brings the particles backward toward the correct brightness level. By applying the triple re-addressing pulses in all four transitions, a generally convergent brightness decay curve is obtained as discussed previously. Moreover, the time between the standard waveform (D) and the additional pulses (RP1, RP2 and RP3) can be varied from zero ms to any time period. The time between the respective re-addressing pulses RP1, RP2 and RP3 can also vary. One advantage of this embodiment is the ease of DC balancing. Additionally, a more accurate final optical state is achieved. In addition, the brightness correction is often fully satisfied since the particles/ions in the display can move in both directions. The choice of the energy (time×voltage level) for each re-addressing pulse can be selected based on similar criteria as discussed in connection with embodiment 2.

In the above embodiments, the time between the different pulses can be varied from Oms to any time period. It is also possible to apply other pulses such as shaking pulses in these time periods, or prior to and/or during these pulses. Shaking pulses are discussed in the above-mentioned European patent application EP 02077017.8 (docket no. PHNL 020441).

The pixels remaining at the same optical state for a significant amount of time may also need to be updated/refreshed to ensure the convergent image stability, and thus the image quality. However, the image is still improved prior to the refresh. A disadvantage in this case is some increase in average power consumption.

### Embodiment 4

FIG. 10 illustrates the example waveforms of FIG. 6, where two re-addressing pulses with the different energies but the same pulse shape in each waveform are also applied. The waveforms 1000, 1020, 1040 and 1060 are used for transitions to the final optical state of white from the initial optical states of black, dark grey, light grey and white, respectively. Here, re-addressing voltage pulses with the same pulse shape but different energies are applied in all four transitions after completion of the standard driving pulse (D) at time tx. Again, the first re-addressing pulse (RP) moves the particles away from the surface of the display associated with the substantially white (SW) state. In this case, the first re-addressing pulse (RP1) has a positive polarity in each respective waveform, but the energy of the first re-addressing pulse in the B-W transition (waveform 1000) is lower than in the DG-W transition (waveform 1020), and in turn lower than in the LG to W transition (waveform 1040) and the W to W transition (waveform 1060). The second re-addressing pulse (RP2) has a negative polarity in each respective waveform but the energy of the second re-addressing pulse (RP2) is different in the different waveforms and is determined by optical performance, i.e., the final optical state to be achieved, as experimentally measured by the electro-optic characterization. The energy of the first re-addressing pulse (RP1) can also be randomly different in the different respective drive waveforms and is determined by optical performance, i.e., the image stability of the final optical state to be achieved, as experimentally measured by the electro-optic characterization. When this approach is applied in all four transitions, a convergent brightness decay curve is achieved. The time between the any of these pulses can be varied from zero ms to any time period.

An advantage of this embodiment is the ease of DC balancing since the two voltages of the re-addressing pulses RP1 and RP2 counter balance one another. Additionally, a more accurate final optical state is achieved. In addition, the brightness correction is often fully satisfied as the particles/ions in the display can move in both directions. As discussed previously, the choice of the energy (time×voltage level) involved in each re-addressing pulse is not limited, but can be determined, e.g., based on the ink or other bi-stable material and the ghosting/brightness requirements. Moreover, to minimize flicker, the energy in the first re-addressing pulse (RP1) may be set so that it is only sufficient to move the particles close to the middle grey level, but insufficient to move the particles to the opposite rail. To maximize the brightness, RP1 is used for reconfiguring the particles, and RP2 is needed to correct the brightness. The choice of the energy in RP1 is less important than for RP2. Experiments show that it is often desirable for the energy in the second re-addressing pulse (RP2) to be larger than in the first re-addressing pulse (RP1). The energy may be varied by varying the time and/or voltage level of the pulse.

### EXPERIMENTAL RESULTS

FIG. 11 illustrates a plot showing a decrease in relative brightness as a function of unpowered image holding time (in seconds) after addressing to the white state from four different initial optical states, where two re-addressing pulses are applied in the driving waveforms as shown in the waveforms of FIG. 8. Similar to FIG. 5, the vertical axis, indicates a relative brightness drop of the white state, while the horizontal axis indicates the unpowered waiting time in seconds. Representative experimental results using the solution of embodiment 2 are shown for a transition to the white state from the initial states of white, black, light grey and dark grey in curves 1100, 1110, 1120 and 1130, respectively. The curves for the initial black state (curve 1110) and the initial white state (curve 1100) essentially overlap one another. The curves for the initial light grey state (curve 1120) and the initial dark grey state (curve 1130) also essentially overlap one another, although curve 1120 is slightly higher at higher waiting times.

When these results are compared with those in FIG. 5, where the re-addressing pulses are not used, it is clear that the divergence of the brightness decay curves is massively reduced with the invention. Thus, a substantially uniform brightness decay versus unpowered holding time characteristic is experienced by the respective portions of the bi-stable display that are driven to the common final optical state from the different initial optical states. For example, a brightness difference of less than about 1-2% at 300 seconds may be achieved. It was also observed on an active matrix electrophoretic display that the image quality is massively improved.

Generally, the particles are much better and more quickly “frozen” by the ions when a small pulse is applied because only a relative short distance movement is needed. With use of the re-addressing pulses according to present invention, the freeze behaviour is made to be the same, regardless of the size or duration of the standard driving waveforms, e.g., which is a function of the initial optical state. The display in the final optical state thus becomes substantially insensitive to the initial optical states.

Accordingly, it can be seen that the invention involves re-addressing the optical states that are substantially achieved using standard driving waveforms from different initial states, by using re-addressing waveforms with substantially the same, or identical, pulse shapes in all relevant transitions towards the desired final optical state. Furthermore, while in the above examples, the white state is used as the desired final optical state to illustrate the problem and the corresponding solutions, a similar approach holds for other final optical states, such as black or intermediate states or other colour states.

Note also that, in the above examples, pulse-width modulated (PWM) driving is used for illustrating the invention, where the pulse time is varied in each waveform while the voltage amplitude is kept constant. However, the invention is also applicable to other driving schemes, e.g., based on voltage modulated driving (VM), where the pulse voltage amplitude is varied in each waveform, or combined PWM and VM driving. The invention is applicable to color as well as greyscale bi-stable displays. Also, the electrode structure is not limited. For example, a top/bottom electrode structure, honeycomb structure, an in-plane switching structure or other combined in-plane-switching and vertical switching may be used. Moreover, the invention may be implemented in passive matrix as well as active matrix electrophoretic displays. In fact, the invention can be implemented in any bi-stable display that does not consume power while the image substantially remains on the display after an image update. Also, the invention is applicable to both single and multiple window displays, where, for example, a typewriter mode exists.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for providing respective voltage waveforms for driving respective portions of a bi-stable display, the method comprising:
accessing data defining the respective voltage waveforms; and
generating the respective voltage waveforms (700, 720, 740, 760; 800, 820, 840, 860; 900, 920, 940, 960; 1000, 1020, 1040, 1060) for driving the respective portions of the bi-stable display (310) according to the accessed data so that each of the respective voltage waveforms is used for driving the respective portion of the bi-stable display from a respective different initial optical state to a common final optical state, and each of the respective voltage waveforms includes at least a first re-addressing pulse (RP, RP1, RP2, RP3).

2. The method of claim 1, wherein:
the generating comprises generating the respective voltage waveforms so that each of the respective voltage waveforms includes the at least a first re-addressing pulse (RP, RP1, RP2, RP3) for providing each of the respective portions of the bi-stable display with a substantially uniform brightness decay versus unpowered holding time characteristic (1100, 1110, 1120, 1130).

3. The method of claim 1, wherein:
the generating comprises generating the respective voltage waveforms so that each of the respective voltage waveforms includes the at least a first re-addressing pulse (RP, RP1, RP2, RP3) with substantially the same energy in each of the respective voltage waveforms.

4. The method of claim 1, wherein:
the generating comprises generating the respective voltage waveforms so that each of the respective voltage waveforms includes the at least a first re-addressing pulse (RP, RP1, RP2, RP3) with substantially the same pulse shape in each of the respective voltage waveforms.

5. The method of claim 4, wherein:
the pulse shape which is substantially the same in each of the respective voltage waveforms comprises at least a first pulse having a first polarity which is the same in each of the respective voltage waveforms.

6. The method of claim 1, wherein:
the generating comprises generating the respective voltage waveforms so that each of the respective voltage waveforms includes a plurality of re-addressing pulses (RP1, RP2, RP3) with substantially the same pulse shape in each of the respective voltage waveforms.

7. The method of claim 6, wherein:
the pulse shape which is substantially the same in each of the respective voltage waveforms comprises the at least a first re-addressing pulse (RP1), which has a first polarity which is the same in each of the respective voltage waveforms, followed by a second re-addressing pulse (RP2), which has a second polarity that is opposite the first polarity, and which is the same in each of the respective voltage waveforms.

8. The method of claim 6, wherein:
the pulse shape which is substantially the same in each of the respective voltage waveforms comprises the at least a first re-addressing pulse (RP1), which has a first polarity which is the same in each of the respective voltage waveforms, followed by a second re-addressing pulse (RP2), which has a second polarity that is opposite the first polarity, and which is the same in each of the respective voltage waveforms, followed by a third re-addressing pulse (RP3), which has the first polarity.

9. The method of claim 1, wherein:
the generating the respective voltage waveforms comprises generating the respective voltage waveforms so that each of the respective voltage waveforms includes a driving pulse (D) preceding the at least a first re-addressing pulse (RP, RP1, RP2, RP3) for driving the respective portion of the bi-stable display from the respective different initial optical state substantially to the common final optical state.

10. The method of claim 1, wherein:
the bi-stable display (310) comprises an electrophoretic display.

11. A program storage device tangibly embodying a program of instructions executable by a machine to perform a method for providing respective voltage waveforms for driving respective portions of a bi-stable display, the method comprising:
accessing data defining the respective voltage waveforms; and
generating the respective voltage waveforms (700, 720, 740, 760; 800, 820, 840, 860; 900, 920, 940, 960; 1000, 1020, 1040, 1060) for driving the respective portions of the bi-stable display (310) according to the accessed data so that each of the respective voltage waveforms is used for driving the respective portion of the bi-stable display from a respective different initial optical state to a common final optical state, and each of the respective voltage waveforms includes at least a first re-addressing pulse (RP, RP1, RP2, RP3).

12. The program storage device of claim 11, wherein:
the generating comprises generating the respective voltage waveforms so that each of the respective voltage waveforms includes the at least a first re-addressing pulse (RP, RP1, RP2, RP3) for providing each of the respective portions of the bi-stable display with a substantially uniform brightness decay versus unpowered holding time characteristic (1100, 1110, 1120, 1130).

13. The program storage device of claim 11, wherein:
the generating comprises generating the respective voltage waveforms so that each of the respective voltage waveforms includes the at least a first re-addressing pulse (RP, RP1, RP2, RP3) with substantially the same energy in each of the respective voltage waveforms.

14. The program storage device of claim 11, wherein:
the generating comprises generating the respective voltage waveforms so that each of the respective voltage waveforms includes a plurality of re-addressing pulses (RP1, RP2, RP3) with substantially the same pulse shape in each of the respective voltage waveforms; and
the pulse shape which is substantially the same in each of the respective voltage waveforms comprises the at least a first re-addressing pulse (RP1), which has a first polarity which is the same in each of the respective voltage waveforms, followed by a second re-addressing pulse (RP2), which has a second polarity that is opposite the first polarity, and which is the same in each of the respective voltage waveforms.

15. The program storage device of claim 11, wherein:
the bi-stable display (310) comprises an electrophoretic display.

16. An electronic reading device, comprising:
a bi-stable display (310); and
a control (100) for providing respective voltage waveforms for driving respective portions of a bi-stable display to a common final optical state by: (a) accessing data defining the respective voltage waveforms, and (b) generating the respective voltage waveforms (700, 720, 740, 760; 800, 820, 840, 860; 900, 920, 940, 960; 1000, 1020, 1040, 1060) for driving the respective portions of the bi-stable display (310) according to the accessed data so that each of the respective voltage waveforms is used for driving the respective portion of the bi-stable display from a respective different initial optical state to a common final optical state, and each of the respective voltage waveforms includes at least a first re-addressing pulse (RP, RP1, RP2, RP3).

17. The electronic reading device of claim 16, wherein:
the generating comprises generating the respective voltage waveforms so that each of the respective voltage waveforms includes the at least a first re-addressing pulse (RP, RP1, RP2, RP3) for providing each of the respective portions of the bi-stable display with a substantially uniform brightness decay versus unpowered holding time characteristic (1100, 1110, 1120, 1130).

18. The electronic reading device of claim 16, wherein:
the generating comprises generating the respective voltage waveforms so that each of the respective voltage waveforms includes the at least a first re-addressing pulse with substantially the same energy in each of the respective voltage waveforms.

19. The electronic reading device of claim 16, wherein:
the generating comprises generating the respective voltage waveforms so that each of the respective voltage waveforms includes a plurality of re-addressing pulses (RP1, RP2, RP3) with substantially the same pulse shape in each of the respective voltage waveforms; and
the pulse shape which is substantially the same in each of the respective voltage waveforms comprises the at least a first re-addressing pulse (RP1), which has a first polarity which is the same in each of the respective voltage waveforms, followed by a second re-addressing pulse (RP2), which has a second polarity that is opposite the first polarity and which is the same in each of the respective voltage waveforms.

20. The electronic reading device of claim 16, wherein:
the bi-stable display (310) comprises an electrophoretic display.
